(19) United States
(12) Patent Application Publication
(10) Pub. No.: US 2009/0328151 A1
(43) Pub. Date: Dec. 31, 2009

(54) Program, apparatus, and method for access control

(75) Inventors: Masahisa Tamura, Kawasaki (JP); Yasuo Noguchi, Kawasaki (JP); Kazutaka Ogihara, Kawasaki (JP); Yoshihiro Tsuchiya, Kawasaki (JP); Tetsutaro Maruyama, Kawasaki (JP); Riichiro Take, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/585,011

(22) Filed: Aug. 31, 2009

Related U.S. Application Data
(63) Continuation of application No. PCT/JP2007/057289, filed on Mar. 30, 2007.

(51) Int. Cl. G06F 21/24; G06F 12/00

(52) U.S. Cl. 726/3; 726/30

(57) ABSTRACT

In a computer which executes an access control program, an authentication information storage unit stores authentication information. A logical volume acquiring unit acquires a logical volume associating data with storage nodes storing the data, from a predetermined database. In response to an access request to access data, a data access unit identifies a storage node to be accessed, based on the logical volume, and sends the authentication information and a command corresponding to the access request to the identified storage node.

This application is a continuing application, filed under 35 U.S.C. §111(a), of International Application PCT/JP2007/057289, filed Mar. 30, 2007.

### FIELD

The embodiment discussed herein is related to a program, apparatus, and method for controlling accesses to a storage system.

### BACKGROUND

The recent spreading of information processing using computers increases the demand on high functionality of storage systems which are used for storing data. For example, high functionality includes high performance for fast reading/writing of a large amount of data and high reliability so as not to lose stored data even if some trouble occurs in part of a hardware system composing a storage system.

A distributed storage system is known as a storage system with high performance and high reliability. In the distributed storage system, data is stored in a distributed manner across a plurality of storage nodes connected over a network, and in many cases, data of the same contents is stored on different storage nodes in duplicate. That is to say, load distribution and data redundancy are implemented by using the plurality of storage nodes.

The distributed storage system provides logical volumes for external computers to access stored data. In the logical volumes, logical addresses are managed by treating the entire distributed storage system as one virtual storage region, and a mapping between logical addresses and physical locations is defined. An external computer first acquires a logical volume from a predetermined database, and identifies a storage node which stores data to be accessed, based on the logical volume. Thereby, the external computer can access the data which is stored in a distributed manner across the plurality of storage nodes.

By the way, in terms of information security such as confidentiality and safety, it is not preferable to permit all accesses without any regulations. A distributed storage system uses an authentication server to collectively perform user authentication (for example, refer to Japanese Unexamined Patent Publications Nos. 2001-75853 and 2005-209118). More specifically, an external computer sends an authentication server authentication information so as to have the own computer authenticated. If the authentication server confirms that the authentication has been successful, the external computer is allowed to access a plurality of storage nodes. The user authentication may be performed at the time of acquiring a logical volume. Such collective user authentication easily restricts accesses to the distributed storage system.

However, in the authentication techniques taught in above Japanese Unexamined Patent Publications Nos. 2001-75853 and 2005-209118, a path for data access and a path for authentication are different, which may make it difficult to perform strict user management. For example, once an external computer is authenticated, this computer can access data without being subjected to further authentication. Therefore, in the case where locations of data or authentication policies are changed while a distributed storage system is running without interruption, users who were authenticated before the change may be able to make fraudulent accesses. However, if validity of authentication is set short for strict user management, an increased number of accesses are made to the authentication server, which results in a heavy burden on the authentication server and a network which is a path for authentication.

### SUMMARY

According to an aspect of the invention, a computer-readable recording medium stores an access control program to be executed by a computer to control accesses to a distributed storage system in which data is stored in a distributed manner across a plurality of storage nodes connected over a network. The access control program, when executed on the computer, causes the computer to perform as: an authentication information storage unit which stores authentication information; a logical volume acquiring unit which acquires a logical volume from a predetermined database, the logical volume associating the data with the plurality of storage nodes storing the data; and a data access unit which identifies a storage node which is an access destination based on the logical volume acquired by the logical volume acquiring unit when an access request to access the data is issued, and sends the authentication information stored in the authentication information storage unit and a command corresponding to the access request to the identified storage node via the network.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWING(S)

FIG. 1 illustrates an outline of an embodiment;

FIG. 2 illustrates a system configuration according to the embodiment;

FIG. 3 illustrates a hardware configuration of a storage node;

FIG. 4 illustrates a hardware configuration of an access node;

FIG. 5 schematically illustrates a data structure of a logical volume;

FIG. 6 is a functional block diagram of a storage node;

FIG. 7 is a functional block diagram of an access node and a control node;

FIG. 8 illustrates an example data structure of a slice information table;

FIG. 9 illustrates an example data structure of a logical volume table;

FIG. 10 illustrates an example data structure of authentication information tables;

FIG. 11 is a flowchart of an access control process;

FIG. 12 is a sequence diagram of the first authentication process;

FIG. 13 is a sequence diagram of the second authentication process; and

FIG. 14 is a sequence diagram illustrating how data is accessed when authentication information is updated.

### DESCRIPTION OF EMBODIMENT(S)

An embodiment of the present invention will now be described with reference to the accompanying drawings, wherein like reference numerals refer to like elements throughout.

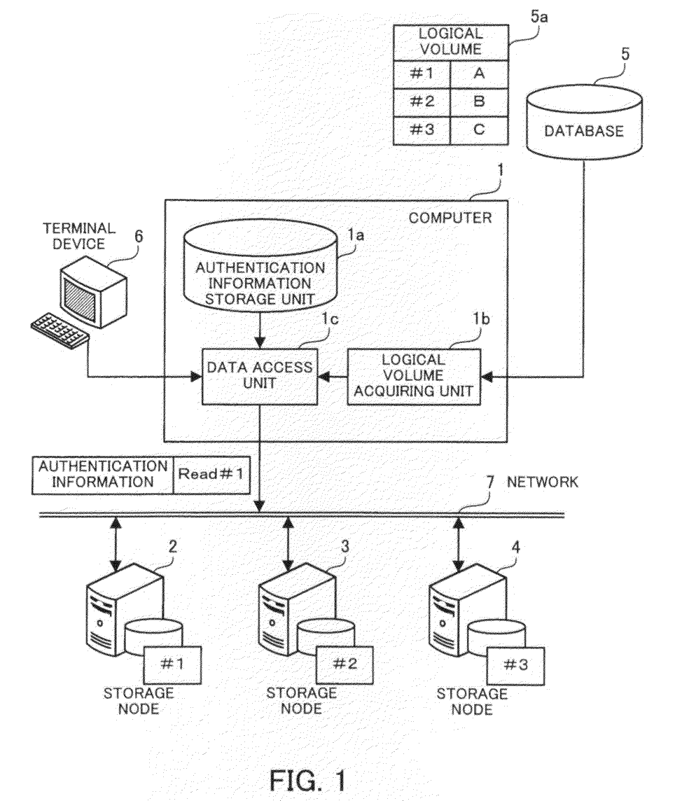

FIG. 1 illustrates an outline of the embodiment. The illustrated distributed storage system includes a computer 1, storage nodes 2 to 4, a database 5, a terminal device 6, and a network 7. The computer 1 and the storage nodes 2 to 4 are connected to the network 7. The database 5 and the terminal device 6 are connected to the computer 1. The computer 1 includes an authentication information storage unit 1a, a logical volume acquiring unit 1b, and a data access unit 1c.

The authentication information storage unit 1a stores authentication information for having accesses to the storage nodes 2 to 4 permitted by authentication. There are two authentication methods. One is to authenticate the computer 1 which is the source of an access. The other is to authenticate the terminal device 6 which makes a data access request or the user of the terminal device 6. For example, in the former one, the Internet protocol (IP) of the computer 1 may be used as the authentication information. In the latter one, a password assigned to the user may be used as the authentication information.

The logical volume acquiring unit 1b acquires a logical volume 5a from the database 5. The logical volume 5a is information which associates data with storage nodes storing the data. The logical volume acquiring unit 1b may be designed to acquire the logical volume 5a in advance or to acquire the logical volume 5a after receiving a data access request from the terminal device 6.

In response to an access request to access data from the terminal device 6, the data access unit 1c identifies a storage node which is an access destination based on the logical volume 5a acquired by the logical volume acquiring unit 1b. The data access unit 1c sends the authentication information stored in the authentication information storage unit 1a and a command corresponding to the access request to the identified storage node via the network 7. The command specifies the type of the request, such as a read request or a write request, and data to be manipulated.

In this connection, the data access unit 1c may be designed to send the authentication information and the command together or to send the authentication information first before the command. Alternatively, the data access unit 1c may be designed to send the authentication information when starting a session with the accessed storage node, and not to send the authentication information while the session is valid. Such a communication method is previously defined in detail between the data access unit 1c and the storage nodes 2 to 4.

Each of the storage nodes 2 to 4 stores a list of authentication information. When receiving the authentication information from the computer 1, the storage node 2, 3, 4 compares it with the stored authentication information. If the received authentication information is found in the list, then the storage node 2, 3, 4 manipulates data in accordance with the command, which arrived together with or after the authentication information, and sends its result to the computer 1. If the received authentication information is not found in the list, on the contrary, the storage node 2, 3, 4 notifies the computer 1 that the access is refused. Then, the computer 1 notifies the terminal device 6 of the result of the access.

As is set in the logical volume 5a, it is assumed that data #1, #2, and #3 are stored in the storage nodes 2 (represented as “A”), 3 (represented as “B”), and 4 (represented as “C”), respectively. In this case, when the terminal device 6 makes a read request to read the data #1, the data access unit 1c identifies the storage node 2 as the access destination based on the logical volume. Then, the data access unit 1c sends the authentication information and a command indicating the read request to read the data #1 to the storage node 2.

In this connection, the database 5 may be provided outside or inside the computer 1. In addition, the computer 1 may be designed to have the functions of the terminal device 6.

With such a computer 1, the logical volume acquiring unit 1b acquires from the database 5 the logical volume 5a which associates data with storage nodes storing the data. When an access request to access data is issued, the data access unit 1c identifies a storage node which is the access destination based on the acquired logical volume 5a, and sends the authentication information and a command corresponding to the access request to the identified storage node via the network 7.

As a result, the same path is used for data access and authentication, which can realize strict authentication without placing a burden on an authentication server and the network which is a path for authentication.

One embodiment will now be described in detail with reference to accompanying drawings.

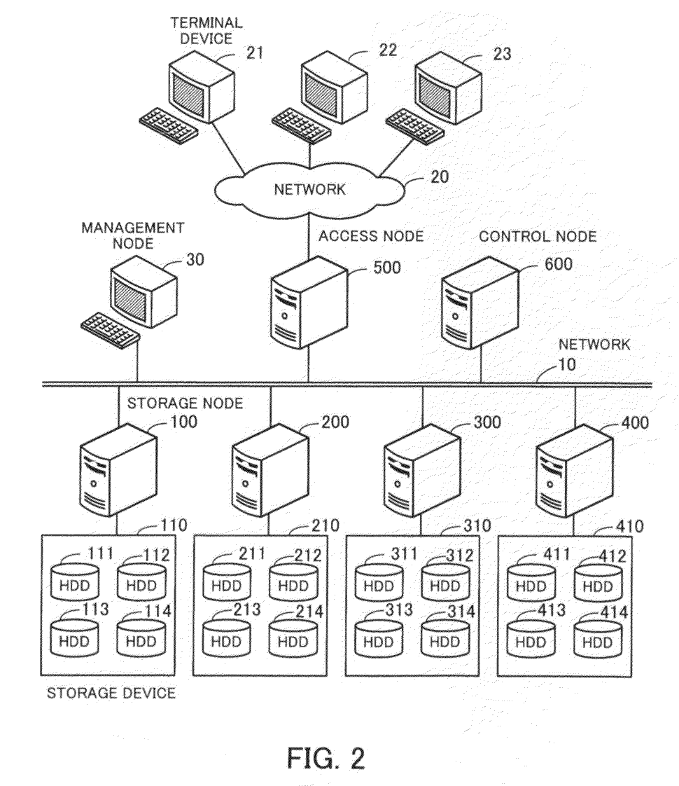

FIG. 2 illustrates a system configuration according to the embodiment. In the illustrated distributed storage system, data is stored in a distributed manner across a plurality of storage nodes connected over a network, thereby providing a storage system with improved reliability and processing performance.

In this distributed storage system, storage nodes 100, 200, 300, and 400, an access node 500, a control node 600, and a management node 30 are mutually connected via a network 10. In addition, terminal devices 21 to 23 are connected to the access node 500 via a network 20.

The storage nodes 100, 200, 300, and 400 are connected to storage devices 110, 210, 310, and 410, respectively, and are designed to manage data stored in the respective storage devices 110, 210, 310, and 410 and provide the managed data for the access node 500 via the network 10.

The storage device 110 is provided with a plurality of hard disk drives (HDD) 111 to 114. Similarly, the storage devices 210, 310, and 410 are provided with a plurality of HDDs 211 to 214, 311 to 314, and 411 to 414, respectively. Each storage device 110, 210, 310, 410 is a Redundant Array of Independent Disks (RAID) system with the plurality of built-in HDDs. In the embodiment, each storage device 110, 210, 310, 410 provides a RAID 5 disk management service.

The access node 500 provides the terminal devices 21 to 23 with an information processing service with the use of the data managed by the storage nodes 100, 200, 300, and 400. That is, the access node 500 executes a predetermined program in response to requests from the terminal devices 21 to 23, and accesses the storage nodes 100, 200, 300, and 400 according to necessity. At this time, the access node 500 acquires a logical volume indicating the locations of data from the control node 600, and identifies a storage node to be accessed, based on the acquired logical volume.

The control node 600 manages the storage nodes 100, 200, 300, and 400. The control node 600 has logical volumes. The control node 600 obtains information necessary for data management from the storage nodes 100, 200, 300, and 400, and updates the logical volumes according to necessity. In addition, when updating a logical volume, the control node 600 notifies a storage node which is affected by the update, of the details of the update. The logical volumes will be described in detail later.

The management node 30 is a terminal device which an administrator of the distributed storage system operates. The administrator of the distributed storage system operates the management node 30 to access the storage nodes 100, 200, 300, and 400, the access node 500, and the control node 600 in order to perform various settings needed for system operation.

The following describes the hardware configuration of the storage nodes 100, 200, 300, and 400, the access node 500, the control node 600, the management node 30, and the terminal devices 21 to 23.

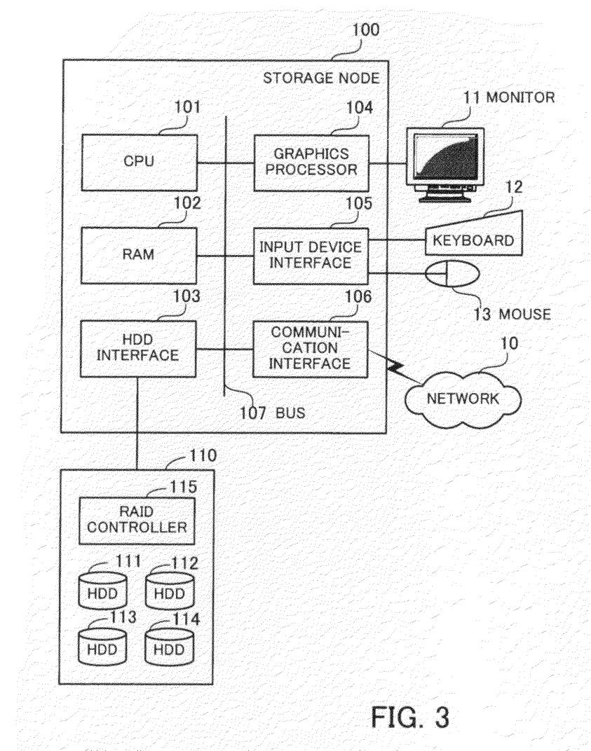

FIG. 3 illustrates a hardware configuration of a storage node. The illustrated storage node 100 is entirely controlled by a Central Processing Unit (CPU) 101. Connected to the CPU 101 via a bus 107 are a Random Access Memory (RAM) 102, an HDD interface 103, a graphics processor 104, an input device interface 105, and a communication interface 106.

The RAM 102 temporarily stores at least part of an Operating System (OS) program and application programs to be executed by the CPU 101. The RAM 102 also stores various kinds of data needed for CPU processing.

The HDD interface 103 is connected to the storage device 110. The HDD interface 103 communicates with a RAID controller 115 installed in the storage device 110 to input/output data in/from the storage device 110. The RAID controller 115 of the storage device 110 has the functions of RAID 0 to RAID 5 to collectively manage the plurality of HDDs 111 to 114 as one hard disk.

The graphics processor 104 is connected to a monitor 11, and is designed to display images on a screen of the monitor 11 under the control of the CPU 101. The input device interface 105 is connected to a keyboard 12 and a mouse 13, and is designed to transfer signals from the keyboard 12 and the mouse 13 to the CPU 101 via the bus 107.

The communication interface 106 is connected to the network 10, and is designed to communicate data with other computers over the network 10.

The storage nodes 200, 300, and 400 can be designed to have the same hardware configuration as the storage node 100.

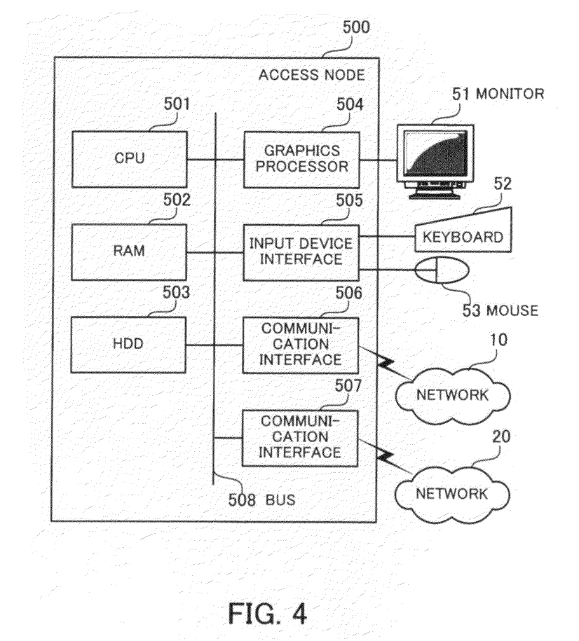

FIG. 4 illustrates a hardware configuration of an access node. The illustrated access node 500 is entirely controlled by a CPU 501. Connected to the CPU 501 via a bus 508 are a RAM 502, a HDD 503, a graphics processor 504, an input device interface 505, and communication interfaces 506 and 507.

The RAM 502 temporarily stores at least part of an OS program and application programs to be executed by the CPU 501. The RAM 502 also stores various kinds of data needed for CPU processing. The HDD 503 stores the OS and application programs.

The graphics processor 504 is connected to a monitor 51, and is designed to display images on a screen of the monitor 51 under the control of the CPU 501. The input device interface 505 is connected to a keyboard 52 and a mouse 53, and is designed to send signals from the keyboard 52 and the mouse 53 to the CPU 501 via the bus 508.

The communication interface 506 is connected to the network 10, and is designed to communicate data with other computers over the network 10. In addition, the communication interface 507 is connected to a network 20, and is designed to communicate data with other computers over the network 20.

The control node 600, the management node 30, and the terminal devices 21 to 23 can be designed to have the same hardware configuration as the access node 500, excepting that there is no need of two communication interfaces.

The processing functions of the embodiment can be realized by using the above hardware configuration.

A logical volume that the control node 600 provides for the access node 500 will now be described. The logical volume is a virtual volume which allows dispersion-managed data on the storage nodes 100, 200, 300, and 400 to be easily accessed from the access node 500.

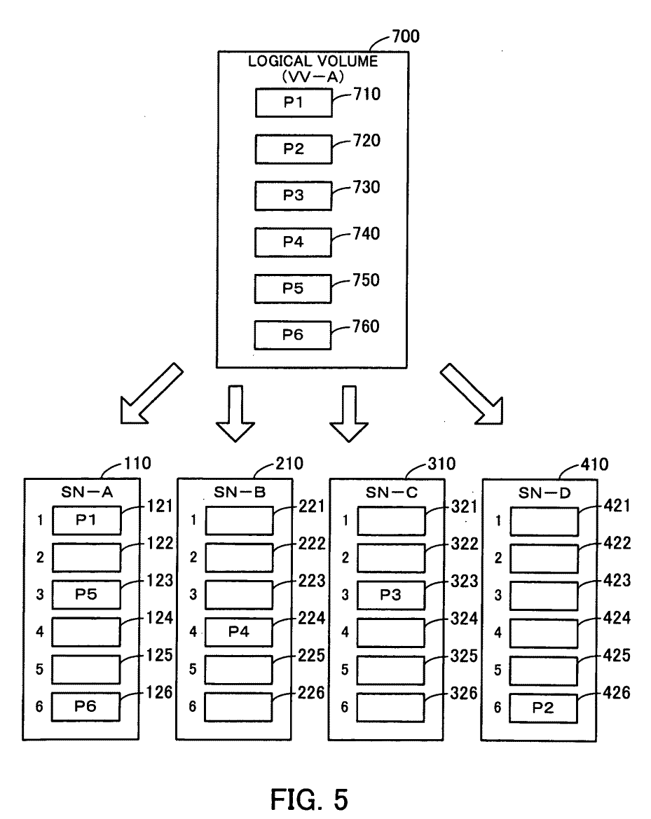

FIG. 5 schematically illustrates a data structure of a logical volume. The logical volume 700 is given a logical volume ID, “VV-A”. In addition, the storage nodes 100, 200, 300, and 400 are given node IDs, “SN-A”, “SN-B”, “SN-C”, and “SN-D”, respectively.

Each of the storage devices 110, 210, 310, and 410 connected to the storage nodes 100, 200, 300, and 400, respectively, has a RAID-5 logical disk. This logical disk is divided into six slices, and is managed in the corresponding storage node.

Referring to FIG. 5, the storage region of the storage device 110 is divided into six slices 121 to 126. Similarly, the storage devices 210, 310, and 410 have six slices 221 to 226, 321 to 326, and 421 to 426, respectively, as storage regions.

The logical volume 700 has segments 710, 720, 730, 740, 750, and 760. Referring to FIG. 5, a segment is given a segment ID which is a combination of a letter “P” and a numeral. The numeral following “P” represents an order of a segment. For example, the first segment 710 is identified by “P1”.

Each segment of the logical volume 700 configured as above is mapped to one slice of the storage devices 110, 210, 310, and 410. For example, the segment 710 is mapped to the slice 121 of the storage device 110. The storage devices 110, 210, 310, and 410 store the data of segments mapped to the own slices.

The following describes the module configuration of the storage nodes 100, 200, 300, and 400, the access node 500, and the control node 600.

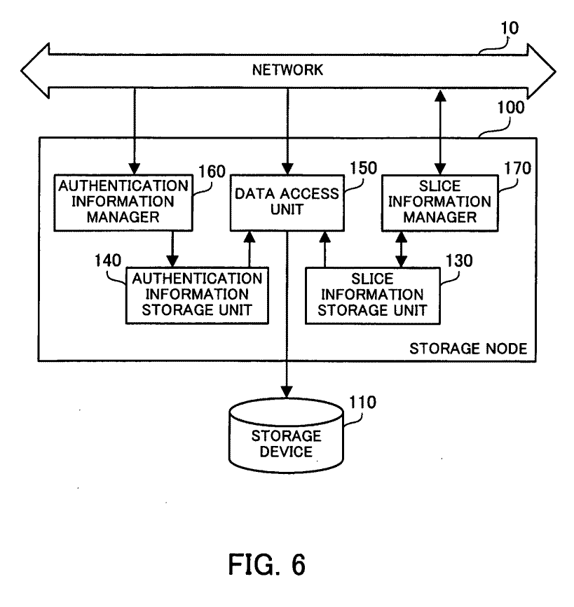

FIG. 6 is a functional block diagram of a storage node. The illustrated storage node 100 includes a slice information storage unit 130, an authentication information storage unit 140, a data access unit 150, an authentication information manager 160, and a slice information manager 170.

The slice information storage unit 130 stores slice information on the slices that the storage device 110 has. The slice information includes an address specifying a slice and a mapping relation between the slice and a segment.

The authentication information storage unit 140 stores a list of authentication information. This list is used for determining whether to permit an access to the storage node 100 or not.

When accepting an access to data, the data access unit 150 refers to the slice information stored in the slice information storage unit 130 and the list of authentication information stored in the authentication information storage unit 140, and manipulates the data in the storage device 110.

More specifically, the data access unit 150 compares the authentication information obtained from the access source with the list of authentication information stored in the authentication information storage unit 140. If the obtained authentication information is not found in the list, the data access unit 150 confirms that the access is fraudulent, and then notifies the access source that the access is refused.

If the obtained authentication information is found in the list, on the contrary, the data access unit 150 manipulates the data in the storage device 110 in accordance with a command which arrived together with or after the authentication information.

More specifically, if the command is a read request specifying an address, the data access unit 150 retrieves the data at the address from the storage device 110, and sends the data to the access source. If the command is a write request specifying an address and data to be written, the data access unit 150 tries to write the data at the specified address in the storage device 110. Then, the data access unit 150 notifies the access source of the result of the writing.

When receiving a command to change authentication information from the management node 30, the authentication information manager 160 updates the list of authentication information stored in the authentication information storage unit 140 in accordance with the command. For example, the authentication information manager 160 adds new authentication information to the list, or deletes specified authentication information from the list. In this connection, the administrator can operate the management node 30 to change the lists of authentication information in the storage nodes 100, 200, 300, and 400 individually or altogether.

The slice information manager 170 periodically notifies the control node 600 of the operational status of the storage node 100. In addition, when receiving a request to send slice information from the control node 600, the slice information manager 170 sends the slice information stored in the slice information storage unit 130. In response to a command to update slice information from the control node 600, the slice information manager 170 updates the slice information in the slice information storage unit 130 in accordance with the command.

The storage nodes 200, 300, and 400 can be designed to have the same module configuration as the storage node 100.

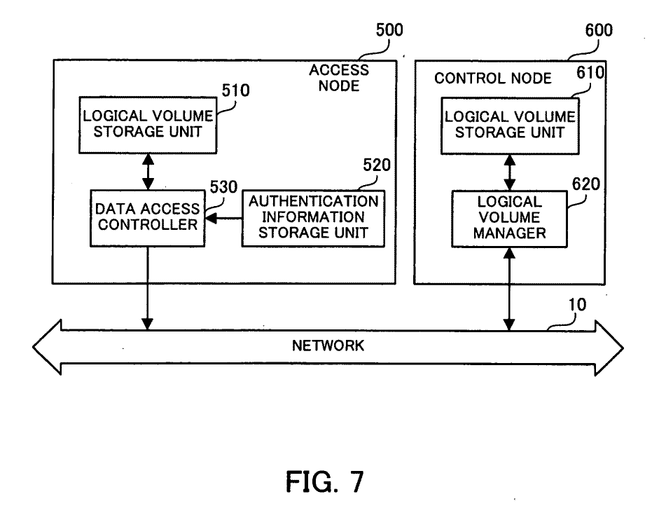

FIG. 7 is a functional block diagram of an access node and a control node.

The illustrated access node 500 includes a logical volume storage unit 510, an authentication information storage unit 520, and a data access controller 530.

The logical volume storage unit 510 stores the same information as the logical volumes managed by the control node 600.

The authentication information storage unit 520 stores authentication information to be used for accessing the storage nodes 100, 200, 300, and 400. More specifically, the IP address of the access node 500 is stored as the authentication information. In addition, account information including a user ID and a password is stored as the authentication information. The account information is obtained by requesting the user of a terminal device 21, 22, 23 to enter them.

In response to an access request to access data from a running program, the data access controller 530 checks whether a logical volume is stored in the logical volume storage unit 510 or not. If a logical volume is not stored, then the data access controller 530 acquires a logical volume from the control node 600, and stores the acquired logical volume into the logical volume storage unit 510.

Then, the data access controller 530 identifies a storage node which is the access destination based on the logical volume. That is, the data access controller 530 identifies a segment to which the data belongs, and then identifies the storage node to which the segment is mapped. Then, the data access controller 530 accesses the identified storage node. At this time, the data access controller 530 sends the identified storage node the authentication information stored in the authentication information storage unit 520.

In this connection, the authentication information may be generated so as to be used in common for all the storage nodes 100, 200, 300, and 400, or different authentication information may be generated for the storage nodes. In addition, the authentication information may be generated so as to be used in common for all logical volumes, or different authentication information may be generated for the logical volumes.

The illustrated control node 600 includes a logical volume storage unit 610 and a logical volume manager 620.

The logical volume storage unit 610 stores at least one logical volume. In a logical volume, segments are managed by using logical addresses, which are virtual addresses, in order to collectively manage all storage regions managed by the storage devices 110, 210, 310, and 410. The logical volume includes logical addresses specifying a segment and information specifying a slice to which the segment is mapped.

The logical volume manager 620 receives notifications of operational status from the storage nodes 100, 200, 300, and 400 over the network 10, and confirms whether the storage nodes 100, 200, 300, and 400 are operating properly. In addition, the logical volume manager 620 obtains slice information from the storage nodes 100, 200, 300 and 400 according to necessity, and updates the logical volumes stored in the logical volume storage unit 610. When updating a logical volume in the logical volume storage unit 610, the logical volume manager 620 notifies a storage node which is affected by the update, of the details of the update.

In addition, in response to a request to send a logical volume from the access node 500, the logical volume manager 620 sends the logical volume stored in the logical volume storage unit 610 to the access node 500.

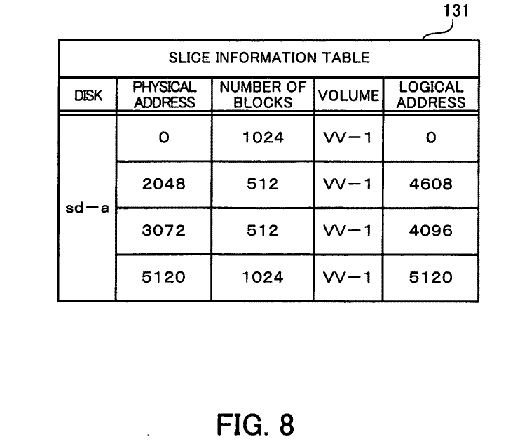

FIG. 8 illustrates an example data structure of a slice information table. The illustrated slice information table 131 is stored in the slice information storage unit 130 of the storage node 100. The slice information table 131 has columns for disk, physical address, the number of blocks, volume, and logical address. Information items arranged in a row are associated with each other to form slice information on one slice.

The disk item contains a disk ID identifying an HDD. The physical address item contains a physical address specifying the first block of a slice. The number-of-blocks item contains the number of blocks included in the slice. The volume item contains a logical volume ID of the logical volume to which a segment mapped to the slice belongs. The logical address item contains the first logical address of the segment mapped to the slice.

The slice information stored in the slice information table 131 is appropriately updated by the slice information manager 170. For example, information including a disk of “sd-a”, a physical address of “3072”, the number of blocks of “512”, a volume of “VV-1”, and a logical address of “4096” is stored. This means that one slice is formed of storage regions of blocks with block numbers from 3072 to 3583 of the disk with the disk ID “sd-a”, and that a segment with logical addresses with block numbers from 4096 to 4607 is mapped to the slice.

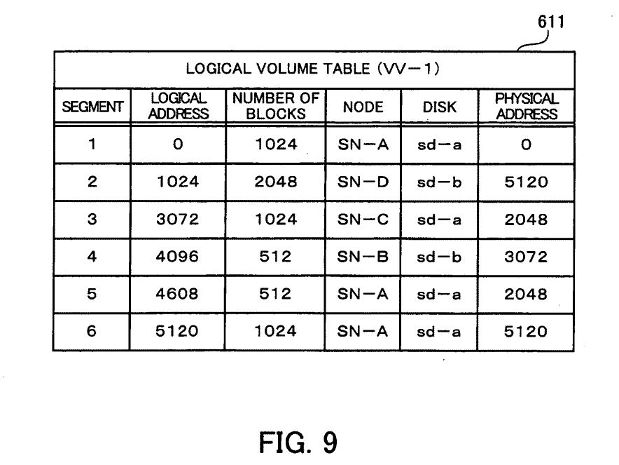

FIG. 9 illustrates an example data structure of a logical volume table. The illustrated logical volume table 611 is a table for a logical volume with a logical volume ID “VV-1”. The logical volume table 611 is stored in the logical volume storage unit 610 of the control node 600. The logical volume table 611 has items for segment, logical address, the number of blocks, node, disk, and physical address. Information items arranged in a row are associated with each other.

The segment item contains a segment ID identifying a segment. The logical address item contains the first logical address of the segment. The number-of-blocks item contains the number of blocks included in the segment. The node item contains a node ID identifying a storage node to which the segment is mapped. The disk item contains a disk ID identifying an HDD in the storage node. The physical address item contains a physical address indicating the first block of the slice to which the segment is mapped.

Information stored in the logical volume table 611 is generated by the logical volume manager 620 based on slice information obtained from the storage nodes 100, 200, 300, and 400.

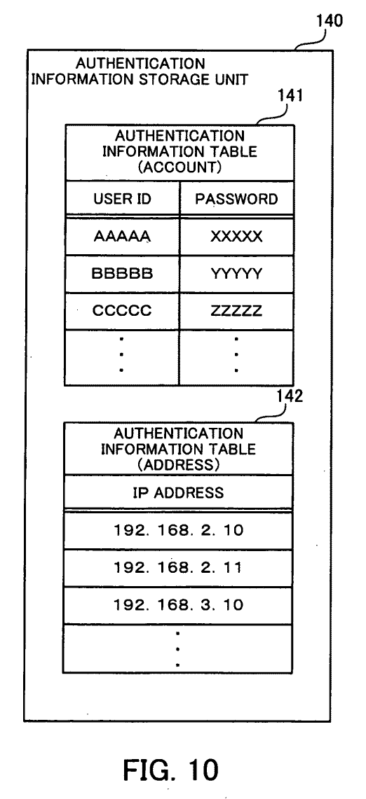

FIG. 10 illustrates an example data structure of authentication information tables. The illustrated authentication information table 141 containing account information and the illustrated authentication information table 142 containing IP addresses are stored in the authentication information storage unit 140 of the storage node 100.

The authentication information table 141 has items for user ID and password. Information items arranged in a row are associated to each other to form one piece of account information. The user ID item contains an ID identifying a user of a terminal device 21, 22, 23. The password item contains a certain letter string specified by the administrator or user.

The authentication information table 142 has a column for IP address. The IP address column contains an IP address specifying a computer which is permitted to access the storage node 100.

Information stored in the authentication information tables 141 and 142 is appropriately updated by the administrator operating the management node 30 to instruct the storage node 100.

The following describes the details of processes to be executed in the system with the above configuration and data structures.

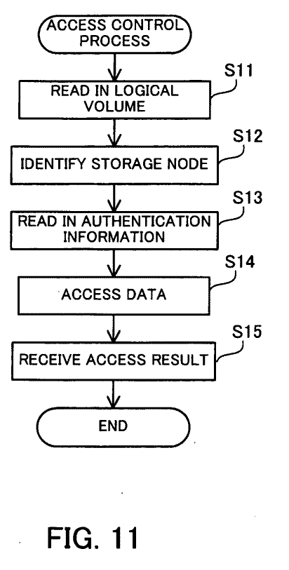

FIG. 11 is a flowchart of an access control process. This flowchart explains how the data access controller 530 of the access node 500 operates when a program running on the access node 500 makes an access request to access data. The flowchart will be described step by step.

At step S11, the data access controller 530 reads in a logical volume from the logical volume storage unit 510. If the logical volume is not stored in the logical volume storage unit 510, the data access controller 530 acquires a logical volume from the control node 600 and stores it in the logical volume storage unit 510.

At step S12, the data access controller 530 identifies a segment to which the data to be accessed belongs, based on the logical volume read in at step S11, and identifies a storage node to which the identified segment is mapped.

At step S13, the data access controller 530 reads in authentication information from the authentication information storage unit 520. If a plurality of authentication information is stored in the authentication information storage unit 520, the data access controller 530 selects and reads in authentication information in accordance with a preset rule. This rule is an authentication method preset by the administrator, for example, what is used for authentication, only account information, only IP address, or both of them.

At step S14, the data access controller 530 accesses the storage node identified at step S12 by using the authentication information read in at step S13, with a preset communication method. The communication method between the access node 500 and the storage node 100, 200, 300, 400 will be described in detail later.

At step S15, the data access controller 530 receives the result of the access from the storage node the data access controller 530 accessed at step S14. The data access controller 530 notifies the program requesting the data access of the access result.

As described above, the access node 500 accesses a storage node 100, 200, 300, and 400 in accordance with a request from the running program. At this time, the access node 500 sends authentication information to the accessed storage node. The accessed storage node performs the authentication process, and only when the authentication process is successful, data is manipulated.

Consider the case where authentication on a session-by-session basis is set. While a session with the storage node identified at step S12 is valid, reading of authentication information at step S13 and transmission of the authentication information at step S14 are omitted.

The following describes the communication between the access node 500 and the storage node 100, 200, 300, 400 in detail. It is assumed that the access node 500 and the storage node 100 perform communication.

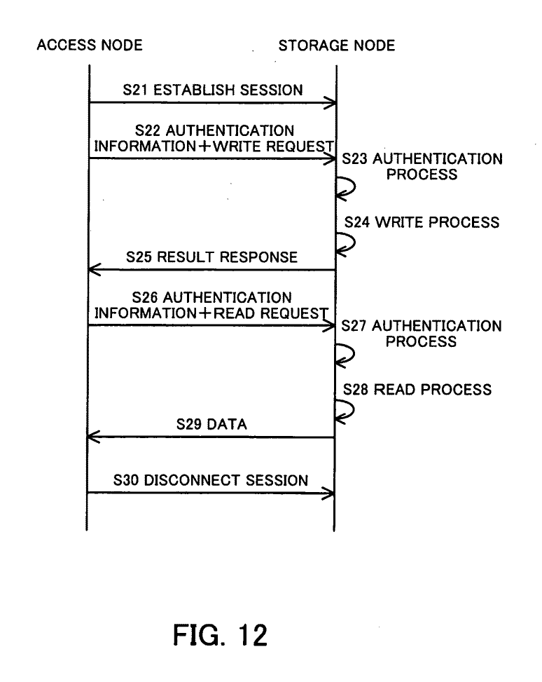

FIG. 12 is a sequence diagram of the first authentication process. This sequence diagram describes an example processing flow for authentication on an access-by-access basis. The sequence will be described step by step.

At step S21, the access node 500 establishes a session with the storage node 100.

At step S22, the access node 500 sends the storage node 100 one piece of communication data including authentication information and the contents of a command. Here, it is assumed that the command is a write request.

At step S23, the storage node 100 performs the authentication process using the authentication information received at step S22. More specifically, the storage node 100 determines whether the access accepted at step S22 has been from a rightful entity. Here, it is assumed that this authentication process is successful.

At step S24, the storage node 100 manipulates data in accordance with the contents of the command received at step S22. That is, the storage node 100 tries to write data in the storage device 110.

At step S25, the storage node 100 informs the access node 500 of the result of writing the data at step S24.

At step S26, the access node 500 sends the storage node 100 one piece of communication data including the authentication information and the contents of a command. Here, it is assumed that the command is a read request.

At step S27, the storage node 100 performs the authentication process using the authentication information received at step S26. More specifically, the storage node 100 determines whether the access accepted at step S26 has been from a rightful entity. Here, it is assumed that this authentication process is successful.

At step S28, the storage node 100 manipulates data in accordance with the contents of the command received at step S26, i.e., retrieves specified data from the storage device 110.

At step S29, the storage node 100 sends the access node 500 the data retrieved at step S28.

At step S30, the access node 500 disconnects the session from the storage node 100.

As described above, in the case of the authentication on an access-by-access basis, the access node 500 sends the storage node 100 the authentication information and the contents of a command each time the access node 500 makes an access. And each time the storage node 100 accepts an access, the storage node 100 performs the authentication process using the received authentication information. Thereby, strict user authentication can be realized.

The sequence diagram of FIG. 12 describes a case where the access node 500 sends authentication information and the contents of a command as one piece of communication data. Alternatively, these may be sent separately. That is, the access node 500 may be designed to first send the authentication information, and after the storage node 100 completes the authentication, send the contents of a command.

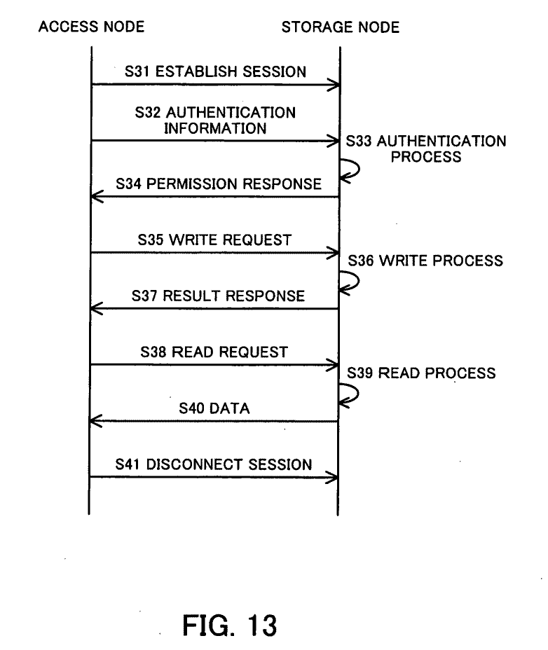

FIG. 13 is a sequence diagram of the second authentication process. This sequence diagram describes an example processing flow for authentication on a session-by-session basis. The sequence will be described step by step.

At step S31, the access node 500 establishes a session with the storage node 100.

At step S32, the access node 500 sends authentication information to the storage node 100.

At step S33, the storage node 100 performs the authentication process using the authentication information received at step S32. Here, it is assumed that the authentication process is successful.

At step S34, the storage node 100 notifies the access node 500 that an access is permitted.

At step S35, the access node 500 sends the storage node 100 the contents of a command. Here, it is assumed that the command is a write request.

At step S36, the storage node 100 manipulates data in accordance with the contents of the command. That is, the storage node 100 tries to write data in the storage device 110.

At step S37, the storage node 100 informs the access node 500 of the result of writing the data at step S36.

At step S38, the access node 500 sends the contents of a command to the storage node 100. Here, it is assumed that the command is a read request.

At step S39, the storage node 100 manipulates data in accordance with the contents of the command received at step S38. That is, the storage node 100 retrieves the specified data from the storage device 110.

At step S40, the storage node 100 sends the access node 500 the data retrieved at step S39.

At step S41, the access node 500 disconnects the session from the storage node 100.

As described above, in the case of the authentication on a session-by-session basis, the access node 500 sends the storage node 100 the authentication information at the time of starting a session. The storage node 100 performs the authentication process using the received authentication information. In the case where the authentication process is successful, an access from the access node 500 to the storage node 100 is permitted until the session is disconnected. Thereby a burden of the authentication process on the storage node 100 can be reduced.

The following describes a case where an access is failed because a list of authentication information stored in the storage node 100 is updated while the access node 500 tries to make accesses to the storage node 100.

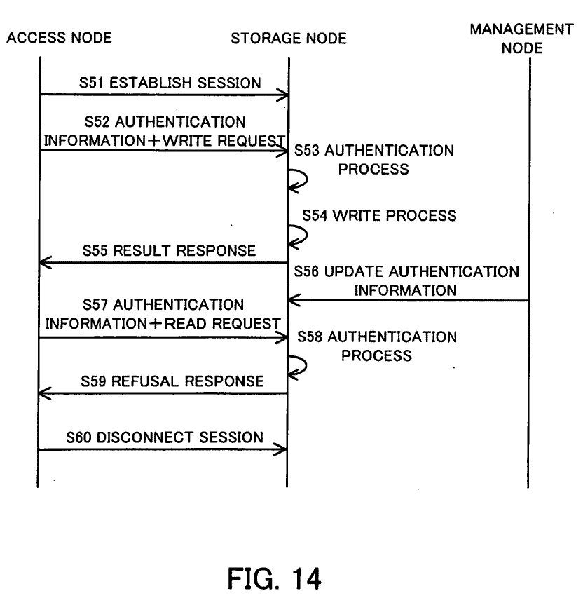

FIG. 14 is a sequence diagram illustrating how data is accessed when authentication information is updated. This sequence diagram describes a case of authentication on an access-by-access basis. The sequence will be described step by step.

At step S51, the access node 500 establishes a session with the storage node 100.

At step S52, the access node 500 sends the storage node 100 one piece of communication data including authentication information and the contents of a command. Here, it is assumed that the command is a write request.

At step S53, the storage node 100 performs the authentication process using the authentication information received at step S52. Here, it is assumed that the authentication process is successful.

At step S54, the storage node 100 manipulates data in accordance with the contents of the command received at step S52. That is, the storage node 100 tries to write data in the storage device 110.

At step S55, the storage node 100 informs the access node 500 of the result of writing the data at step S54.

At step S56, the management node 30 instructs the storage node 100 to update the list of authentication information in response to an operational input from the administrator. The storage node 100 updates the list of authentication information in accordance with the command from the management node 30. Here, it is assumed that a password needed for an access has been changed.

At step S57, the access node 500 sends the storage node 100 one piece of communication data including the authentication information and the contents of a command. Here, it is assumed that the command is a read request.

At step S58, the storage node 100 performs the authentication process using the authentication information received at step S57. Now, the authentication process is failed because the password needed for the access was changed at step S56.

At step S59, the storage node 100 informs the access node 500 that the access is refused.

At step S60, the access node 500 disconnects the session from the storage node 100.

As described above, even when the list of authentication information is changed, the storage node 100 is capable of confirming the updated list in real-time and determining whether to permit or refuse an access. Thus, stricter user authentication can be realized.

In such a distributed storage system, a storage node performs an authentication process when an access to the storage node is requested. Thereby, the same path is used for data access and authentication. Therefore, as compared with a case where an authentication server always performs an authentication process when a logical volume is to be acquired, it is possible to realize strict authentication while reducing a burden on the authentication server and a network which is a path for authentication.

Especially, even if location of segments or authentication information is dynamically changed without interrupting the distributed storage system, it is possible to prevent users who were authenticated before the change from making fraudulent accesses.

The processing functions described above can be realized by a computer. In this case, a program is prepared, which describes processes for the functions to be performed by the storage nodes 100, 200, 300, and 400, the access node 500, and the control node 600. The program is executed on a computer, whereupon the aforementioned processing functions are accomplished by the computer. The program describing the required processes may be recorded on a computer-readable recording medium. Computer-readable recording media include magnetic recording devices, optical discs, magneto-optical recording media, semiconductor memories, etc. The magnetic recording devices include Hard Disk Drives (HDD), Flexible Disks (FD), magnetic tapes (MT), etc. The optical discs include Digital Versatile Discs (DVDs), DVD-RAMs, Compact Disc Read-Only Memories (CD-ROMs), CD-R (Recordable)/RW (ReWritable), etc. The magneto-optical recording media include Magneto-Optical disks (MOs) etc.

To distribute the program, portable recording media, such as DVDs and CD-ROMs, on which the program is recorded may be put on sale. Alternatively, the program may be stored in the storage device of a server computer and may be transferred from the server computer to other computers through a network.

A computer which is to execute the above program stores in its storage device the program recorded on a portable recording medium or transferred from the server computer, for example. Then, the computer runs the program. The computer may run the program directly from the portable recording medium. Also, while receiving the program being transferred from the server computer, the computer may sequentially run this program.

This embodiment is designed to identify a storage node which is an access destination based on a logical volume when an access request is issued, and send authentication information to the identified storage node. That is, the storage node performs an authentication process when accepting the data access. Therefore, the same path is used for the data access and authentication, thus making it possible to perform strict authentication without putting a burden on an authentication server and a network which is a path for authentication.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has (have) been described in detail, it should be understood that various changes, substitutions, and alterations could be made hereto without departing from the spirit and scope of the invention.

What is claimed is:

1. A computer-readable recording medium storing an access control program to be executed by a computer to control accesses to a distributed storage system in which data is stored in a distributed manner across a plurality of storage nodes connected over a network, the access control program, when executed on the computer, causing the computer to perform as:
an authentication information storage unit which stores authentication information;
a logical volume acquiring unit which acquires a logical volume from a predetermined database, the logical volume associating the data with the plurality of storage nodes storing the data; and
a data access unit which identifies a storage node which is an access destination based on the logical volume acquired by the logical volume acquiring unit when an access request to access data is issued, and sends the authentication information stored in the authentication information storage unit and a command corresponding to the access request to the identified storage node via the network.

2. The computer-readable recording medium according to claim 1, wherein:
an address space of the logical volume is divided into a plurality of logical segments, and the data is associated with the plurality of storage nodes for each of the plurality of logical segments; and
the data access unit identifies a logical segment to which the data specified by the access request belongs, and identifies the storage node to which the identified logical segment is mapped, as the access destination.

3. The computer-readable recording medium according to claim 1, wherein
the data access unit sends the authentication information and the command when starting a session with the identified storage node, and
while the session is valid, the data access unit does not send the authentication information but sends a command corresponding to another access request to the identified storage node.

4. An access control apparatus for controlling accesses to a distributed storage system in which data is stored in a distributed manner across a plurality of storage nodes connected via a network, the access control apparatus comprising:
an authentication information storage unit which stores authentication information;
a logical volume acquiring unit which acquires a logical volume from a predetermined database, the logical volume associating the data with the plurality of storage nodes storing the data; and
a data access unit which identifies a storage node which is an access destination based on the logical volume acquired by the logical volume acquiring unit when an access request to access data is issued, and sends the authentication information stored in the authentication information storage unit and a command corresponding to the access request to the identified storage node via the network.

5. The access control apparatus according to claim 4, wherein:
an address space of the logical volume is divided into a plurality of logical segments, and the data is associated with the plurality of storage nodes for each of the plurality of logical segments; and
the data access unit identifies a logical segment to which the data specified by the access request belongs, and identifies the storage node to which the identified logical segment is mapped, as the access destination.

6. The access control apparatus according to claim 4, wherein
the data access unit sends the authentication information and the command when starting a session with the identified storage node, and
while the session is valid, the data access unit does not send the authentication information but sends a command corresponding to another access request to the identified storage node.

7. An access control method for controlling accesses to a distributed storage system in which data is stored in a distributed manner across a plurality of storage nodes connected via a network, the access control method comprising:
acquiring, by a logical volume acquiring unit, a logical volume from a predetermined database, the logical volume associating the data with the plurality of storage nodes storing the data; and
identifying, by a data access unit, a storage node which is an access destination based on the logical volume acquired by the logical volume acquiring unit when an access request to access data is issued, and sending authentication information stored in an authentication information storage unit and a command corresponding to the access request to the identified storage node via the network.

8. The access control method according to claim 7, wherein:
an address space of the logical volume is divided into a plurality of logical segments, and the data are associated with the plurality of storage nodes for each of the plurality of logical segments; and
at a time of accessing the data, the data access unit identifies a logical segment to which the data specified by the access request belongs, and identifies the storage node to which the identified logical segment is mapped, as the access destination.

9. The access control method according to claim 7, wherein,
at a time of accessing data, the data access unit sends the authentication information and the command when starting a session with the identified storage node, and
while the session is valid, the data access unit does not send the authentication information but sends a command corresponding to another access request to the identified storage node.
